(19) United States
(12) Patent Application Publication
(10) Pub. No.: US 2017/0320461 A1
(43) Pub. Date: Nov. 9, 2017

(54) PET VEHICLE SAFETY SEAT

(71) Applicant: Stephanie Talevich, Seattle, WA (US)

(72) Inventor: Stephanie Talevich, Seattle, WA (US)

(21) Appl. No.: 15/149,671

(22) Filed: May 9, 2016

(51) Int. Cl. B60R 22/10; B60N 3/00; B60N 2/24; B60N 3/10; A01K 15/04

(52) U.S. Cl. CPC B60R 22/10; B60N 3/10; A01K 15/04; B60N 2/24; B60N 3/002

(57) ABSTRACT

A pet vehicle safety seat is provided. The vehicle safety seat comprises a frame and a support assembly coupled to the frame. The frame has a base portion coupled to surrounding upwardly extending walls to enclose an animal. The upwardly extending walls comprising a forward wall, a rear wall and two sidewalls. The support assembly is used to releasably attach the rear wall of the frame to a vehicle seat. Thereupon, the base portion of the frame supports the animal at an elevated position relative a sitting surface of the vehicle seat.

### TECHNICAL FIELD

Embodiments of the present disclosure relate generally to a vehicle safety device, and more specifically, but without limitation, to a pet vehicle safety seat.

### BACKGROUND

When small animals like pet dogs or cats are left unrestrained in a vehicle, they often move about the vehicle's cabin. For example, small dogs may attempt to jump up in the cabin to see through a window of the vehicle. This can present dangers for the pet, the vehicle's driver as well as other occupants in the cabin. For example, an unrestrained pet may collide with parts within the vehicle's cabin or the other occupants, such as when the vehicle suddenly stops, accelerates or turns sharply. In some situations, the unrestrained pet may jump out of an open window of the vehicle, resulting in injury or death of the pet. In other situations, the unrestrained pet may distract the driver, thereby causing a collision or other types of vehicle accidents.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 is a perspective view of an elevated vehicle safety seat for pets shown operatively supported on a vehicle passenger seat in accordance with embodiments of the present disclosure.

FIG. 2 is an illustration of an example of a vehicle safety seat in accordance with one embodiment of the present disclosure.

FIG. 3 is an illustration of an example of a support assembly in accordance with one embodiment of the present disclosure.

FIG. 4 is another illustration of an example of a vehicle safety seat in accordance with one embodiment of the present disclosure.

FIG. 5 is illustration of an example of a tray assembly in accordance with one embodiment of the present disclosure.

### DETAILED DESCRIPTION

Embodiments of the present disclosure provide an elevated vehicle safety seat, for example, for transporting one or more animals or pets in a vehicle (e.g., automobile). Some animals or pets, such as small dogs, if they cannot see out of the windows of a vehicle, they may become overly excited or sick due to motion sickness. This can lead to a pet injuring itself or other occupants of the vehicle. If, however, the pets are able to view their surroundings, they are typically more relaxed so that they can enjoy the ride.

In accordance with the present disclosure an elevated vehicle safety seat is provided that allows a pet to be secured within a vehicle while also being able to view outside during travel. In some embodiments, the elevated vehicle safety seat may include a frame that is mounted to a vehicle passenger seat so that pets restrained therein can easily view outer surroundings through a window of the vehicle. In order to restrain a pet to the vehicle safety seat, a strap is coupled to the pet's harness from the back of the frame. In other embodiments, the portion of the frame may include a curved lip portion so that the pet can rest its head on during the ride.

The vehicle safety seat includes a support assembly (e.g., strap) to secure the safety seat to the upper portion (e.g., around the headrest post) of a vehicle's passenger seat. The support assembly supports the safety seat at an elevated position relative a sitting surface of the passenger seat. For example, the support assembly may include a strap that is wrapped around and secured (e.g., using a locking assembly) to the upper portion of the passenger seat such that a base of the vehicle safety seat is suspended above the sitting surface of the passenger seat. In another embodiment, the vehicle safety seat may be adapted to receive a tray for storing pet supplies underneath the pet for easy access.

The present disclosure relates to an apparatus for performing the operations herein. In the following description, numerous details are set forth. It will be apparent, however, to one skilled in the art, that the present disclosure may be practiced without these specific details. In some instances, well-known structures and devices are shown in block diagram form, rather than in detail, in order to avoid obscuring the present disclosure.

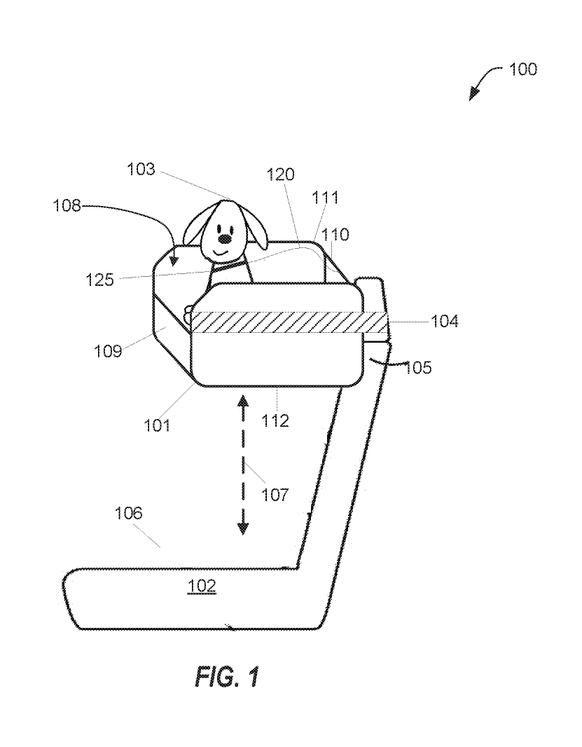

FIG. 1 is a perspective view 100 of an elevated vehicle safety seat 101 for pets shown operatively supported on a vehicle passenger seat 102 in accordance with embodiments of the present disclosure. The vehicle safety seat 101 provides for secure retention of one or more pets, such as pet 103, within a motor vehicle during travel. In some embodiments, the vehicle safety seat 101 is adapted for use to carry the pet 103, such as a small dog or cat, in a manner that enables the pet 103 to view the outer surroundings of the vehicle through the vehicle's windows.

As shown in FIG. 1, pet 103 rests inside of the vehicle safety seat 101, which is securely supported by a support assembly 104 for removably supporting the safety seat 101 onto the passenger seat 102 of a vehicle. In various embodiments and installations, the support assembly 104 may rest upon an upper portion of the passenger seat 102, such as seat back head rest 105. In some embodiments, the support assembly 104 maintains the vehicle safety seat 101 in a secured position around the seat back head rest 105. This is so that the safety seat 101 is positioned forward of the seat back 105 with a base of the safety seat 101 spaced above the passenger seat base 106 at a certain distance as indicated by arrows 107. The vehicle safety seat 101 as maintained by the support assembly 104 is generally perpendicular to the seat back 105 so that the seat base 106 remains horizontal. As such, the vehicle safety seat 101 does not engage a top surface of the passenger seat base 106 of the passenger seat 102 or any other surface such as the floor of the vehicle.

In some embodiments, the vehicle safety seat 101 includes a central sitting area 108 for placing the pet 103 that is enclosed by walls extending upward, such as walls 109, 110, 111 and 112. The upwardly extending walls include a forward wall 109, a rear wall 110, and opposite side walls 111, 112. In some embodiments, the walls 109-112 may be of different heights with the forward wall 109 having a lower height than the rear wall 110. An advantage of the relatively lower forward wall 109 is that it enables smaller pets to have an unobstructed view forward, without the confining effect of a higher forward wall. Another advantage of this arrangement is that it provides good lateral security for the pet 103 secured within the central sitting area 108, and also for mounting of a restraining strap or leash for the pet 103, as discussed below.

To restrain the pet within the vehicle safety seat 101, a restraining leash assembly 120 is provided. The restraining leash assembly 120 includes a leash cord that is fitted at one end to the rear wall 110 of the vehicle safety seat 101 and is adjustable in length. The other end of the leash cord is attached to an appropriate type of pet restraining device 125 (e.g., a harness) or other types of well-known pet restraining devices. An advantage of using a harness is that it more evenly distributes any stresses over an upper torso of the pet 103 and lessens the chance of injury. Thus, when the pet 103 is placed within the central sitting area 108 and secured to the vehicle safety seat 101 by attaching the restraining leash assembly 120 to the pet restraining device 125, the pet 103 is safely positioned within the vehicle and ready for travel.

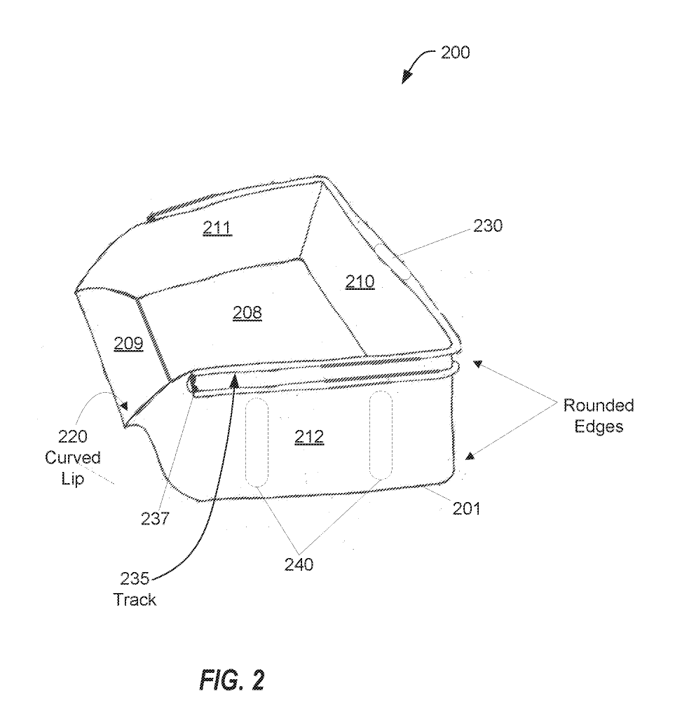

FIG. 2 is an illustration of an example of a vehicle safety seat 200 in accordance with one embodiment of the present disclosure. Vehicle safety seat 200 may be compared and is configured similar to the vehicle safety seat 100 from FIG. 1. For example, the vehicle safety seat 200 includes a frame 201 that has a central sitting area 208 (which may be compared to central sitting area 108 of FIG. 1) for placing a pet like pet 103. The frame 201 also includes upwardly extending walls 209, 210, 211 and 212 that are surrounding or otherwise enclosing the central sitting area 208. The upwardly extending walls include a forward wall 209, a rear wall 210, and opposite side walls 211, 212 (which may be compared respectively to the forward wall 109, rear wall 110, and opposite side walls 111, 112 of the vehicle safety seat 100 of FIG. 1).

Frame 201 of the vehicle safety seat 200 may be constructed of several types of material. In some embodiments, the frame 201 may be constructed of a type of plastic. In one embodiment, the frame 201 may be molded out of plastic or other moldable material. In other embodiments, metals, woods, and other types of composites may also be used. In one embodiment, the frame 201 may be formed as one piece. In alternative embodiments, the frame 201 may include several pieces that are assembled to form the vehicle safety seat 200.

Walls 209-212 of the vehicle safety seat 200 may be of different heights. For example, the forward wall 209 may have a lower height than the rear wall 210. As noted above, an advantage of the relatively lower forward wall 209 is that it enables smaller pets to have an unobstructed view forward. In one embodiment, lower forward wall 209 may also include a curved lip portion 220. The curved lip portion 220 includes a portion of the forward wall 209 extending outwardly from the central sitting area 208 and downwardly sloped relative to the upward project of the forward wall 209. In some embodiments, the curved lip portion 220 has a shape to conform to a specific curvature associated with an outer surface of the frame 201. An advantage of the specific curvature of the forward wall 209 is that it provides a comfortable headrest for a pet sitting in the central sitting area 208 of the vehicle safety seat 200.

In some embodiments, a pet may be secured within the safety seat 200 by using a restraining device attached to one of the upwardly extending walls. As shown in FIG. 2, the rear wall 210 of the safety seat 200 may include a central restraining strap passage way 230 or cavity for receiving a restraining device, such as a leash, to keep the pet in the central sitting area 208. In operation, one end of a leash is secured to the central restraining strap passage way 230 and extends forwardly therefrom. The forward end of the leash is then attached to a pet harness or collar of the pet. In some embodiments, the leash may be attached to the central restraining strap passage way 230 using pins, fasteners, or the like to secure the leash to the passage way.

In some embodiments, the vehicle safety seat 200 may have vents 240 disposed on its sides to facilitate ventilation of the central sitting area 208, as well as to provide extra viewing capability to a pet sitting inside of the vehicle safety seat 200. In one embodiment, the vehicle safety seat 200 is provisioned to have soft rounded edges along a substantial part of the perimeter and inside of the frame 201. An advantage of the soft rounded edge is that any sudden movement of the vehicle safety seat 200 which may cause the pet to lose balance will, as a result, be less harmful or injurious to the pet since the soft rounded edge will provide a type of cushion for the impact. In addition, the soft rounded edges are less likely to cause damage to the passenger seat that the safety seat 200 is attached or to any occupants of the vehicle if the safety seat 200 becomes dislodged or somehow moves.

To secure the vehicle safety seat 200 inside of a vehicle, it may be attached to a vehicle passenger seat. For example, the vehicle safety seat 200 may be attached to vehicle passenger seat using a support assembly that includes a strap. In some embodiments, the strap may be feed through a guide track 235 disposed on the safety seat 200. As shown in FIG. 2, the guide track 235 is indented on an outer surface of side wall 212. Although not shown, a similar guide track is disposed on the outside of side wall 211. When the strap is fed through the guide track 235, a portion of the strap may begin at a forward end the vehicle safety seat 200 closest to the forward wall 209 and moved to the rear end of the safety seat 200.

To help secure the strap to the guide track 235, the vehicle safety seat 200 may include a loop shaped holder 237, clip, binder or another kind of holding device to hold the strap within the guide track 235. The strap is then fed further into the guide track 235 towards the rear end wall 210. Similarly, another strap is fed along the guide track positioned on the outside of side wall 211. At this point the two straps are wrapped around passenger seat and locked together using a locking assembly. Thus, securing the vehicle safety seat 200 to the passenger seat at an elevated position that allows the pet secured therein to observe the outside world during travel.

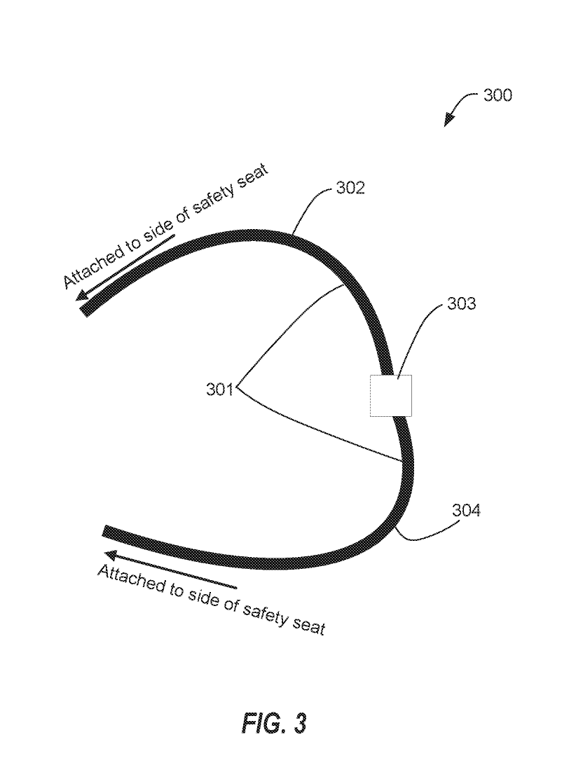

FIG. 3 is an illustration of an example of a support assembly 300 in accordance with one embodiment of the present disclosure. In some embodiments, the support assembly 300 is used to secure the vehicle safety seat 200 to a vehicle passenger seat. The support assembly 300 may include one or more straps, such as strap 301, having a first portion 302 and a second portion 304. In some embodiments, the support assembly 300 for the vehicle safety seat 200 the may include one or more additional straps to hold the safety seat to the vehicle passenger seat. Depending on the type and location of vehicle passenger seat (e.g., a front or back seat), the additional straps may be arranged is several ways. For example, the additional straps may include a lower strap to go from the safety seat to around the lower portion of the passenger seat (such as for a front seat) or an additional strap may be attached to a seat belt of the passenger seat (such as for a back seat). An advantage of the additional straps is that they will help hold down the safety seat 200 in the event of a sudden jolt of the vehicle, such as in an auto accident.

The strap 301 be made of a resilient type of fabric and the like, which can resist a certain amount of tension to support the weight of the vehicle safety seat 200 and of the one or more pets secured therein. In some embodiments, to secure the vehicle safety seat 200 with the support assembly 300, the first and second portions 301 and 302 are each attached to a side of the safety seat. Then, the first and second portions 301 and 302 are positioned around an upper portion of the vehicle passenger seat. For example, each of the first and second portions 301 and 302 may be of a sufficient length to be fed through the guide track 235 of the vehicle safety seat 200 in order to reach a back portion of the passenger vehicle seat. When each portion reaches the back of the passenger vehicle seat, they are locked together using locking assembly 303.

In some embodiments, the locking assembly 303 may be a commonly known or unknown type of device used to secure two straps together. In one embodiment, the locking assembly 303 permits movement of the strap 302 in an insertion direction (e.g., bring the first and second portions 301 and 302 together) and prevents substantial movement of the strap 302 in a withdrawal direction (e.g., separating the first and second portions 301 and 302). Thus, when the strap 302 is locked in position by using the locking assembly 303, the vehicle safety seat 200 will be tightly secured to the vehicle passenger seat.

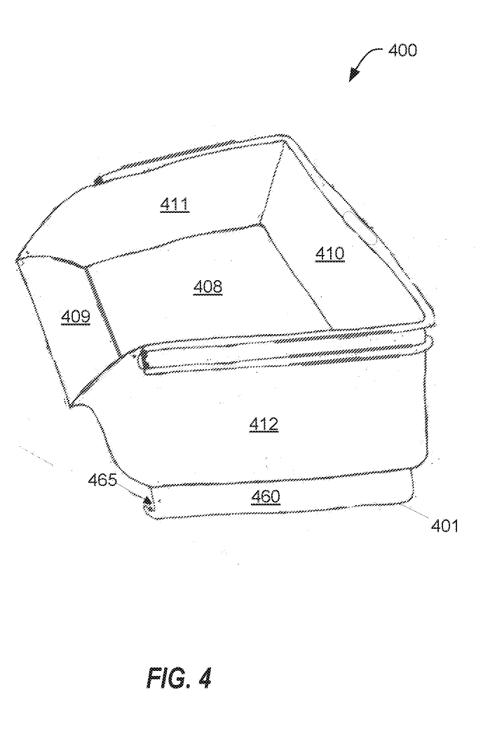

FIG. 4 is another illustration of an example of a vehicle safety seat 400 in accordance with one embodiment of the present disclosure. Vehicle safety seat 400 may be compared and is configured similar to the vehicle safety seat 100 from FIG. 1 and vehicle safety seat 200 from FIG. 2. For example, the vehicle safety seat 400 includes a frame 401 that has a central sitting area 408 (which may be compared to central sitting area 108 of FIG. 1 and central sitting area 208 of FIG. 2) for placing a pet like pet 103. Frame 401 also includes upwardly extending walls 409, 410, 411 and 412 that are surrounding the central sitting area 408. The upwardly extending walls include a forward wall 409, a rear wall 410, and opposite side walls 411, 412 (which may be compared respectively to the forward wall 109, rear wall 110, and opposite side walls 111, 112 of the vehicle safety seat 100 of FIG. 1 and the forward wall 209, rear wall 210, and opposite side walls 211, 212 of the vehicle safety seat 100 of FIG. 1).

In this example, the vehicle safety seat 400 includes housing for a storage compartment 460. In some embodiments, the storage compartment 460 may be made of the same or similar material as the safety seat 400. For example, the storage compartment 460 may be molded out of plastic or other moldable material. In other embodiments, metals, woods, and other types of composites may also be used. In one embodiment, the storage compartment 460 may be formed as one piece. In alternative embodiments, the storage compartment 460 may include several pieces that are attached to a portion of the vehicle safety seat 400.

As shown in FIG. 4 merely as an illustrative example, the storage compartment 460 may be attached to a base portion of the frame 401 of the vehicle safety seat 400. The storage compartment 460 may be used to store pet supplies (e.g., food, water, leash, toys, etc.) for the pet. In this regard, the storage compartment 460 may receive a type of a tray assembly to stow the pet supplies underneath the base portion. For example, the storage compartment 460 includes an opening 465 in which the tray assembly may be inserted into the storage compartment 460.

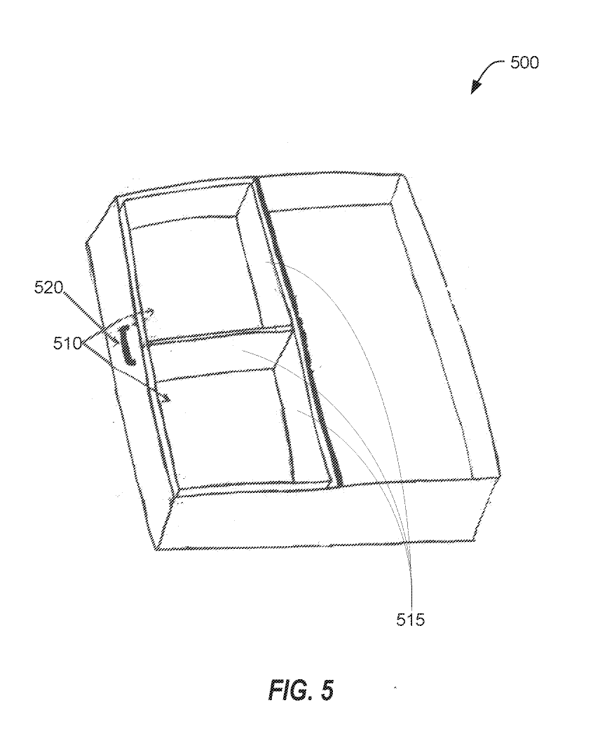

The tray assembly for storing in the storage compartment 460 may take many forms. In FIG. 5, an example of a tray assembly 500 in accordance with one embodiment of the present disclosure is shown. In some embodiments, the tray assembly 500 includes one more storage compartments 510 for storing the pet supplies, one or more separators 515 to define an area for each compartment, a pulling mechanism 520 (e.g., a handle) for pulling and securing the tray assembly 500 in and out of, and to the storage compartment 460 as well as other components.

In some embodiments, the tray assembly 500 may be made of the same or similar material and the storage compartment 460 and the vehicle safety seat 400. For example, the tray assembly 500 may be molded out of plastic or other moldable material. In other embodiments, metals, woods, and other types of composites may also be used. In one embodiment, the tray assembly 500 may be formed as one piece. In alternative embodiments, the tray assembly 500 may include several pieces that are assembled to form the various storage compartments. An advantage of the tray assembly 500 is that it provides a place close to the vehicle safety seat 400 for storing supplies or even toys that may be used to calm the pet during the ride.

Reference throughout this specification to “one embodiment” or “an embodiment” means that a particular feature, structure, or characteristic described in connection with the embodiment is included in at least one embodiment of the disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. A vehicle safety seat, comprising:
a frame having a base portion coupled to surrounding upwardly extending walls to enclose an animal, the upwardly extending walls comprising a forward wall, a rear wall and two sidewalls; and
a support assembly coupled to the frame, the support assembly is used to releasably attach the rear wall of the frame to a vehicle seat, wherein the base portion of the frame supports the animal at an elevated position relative a sitting surface of the vehicle seat.

2. The vehicle safety seat of claim 1, wherein the frame is secured to an upper portion of the vehicle seat by wrapping the support assembly around the headrest portion.

3. The vehicle safety seat of claim 1, further comprising a track disposed on the frame to guide the support assembly around the upper portion.

4. The vehicle safety seat of claim 1, wherein the support assembly comprises a strap having a first portion and a second portion, wherein the first and second portions are adapted to reach around the headrest portion of the vehicle seat.

5. The vehicle safety seat of claim 4, further comprising a locking assembly attached to the support assembly, wherein the locking assembly to secure the first and second portions together.

6. The vehicle safety seat of claim 1, wherein the base portion comprises a restraining area.

7. The vehicle safety seat of claim 6, further comprising a restraining leash assembly coupled to the frame to restrain the animal in the restraining area.

8. The vehicle safety seat of claim 7, wherein the restraining leash assembly is releasably attached to a restraining device for the animal and the rear wall of the frame.

9. The vehicle safety seat of claim 8, wherein the rear wall of the frame comprising a cavity to receive a portion of the restraining device.

10. The vehicle safety seat of claim 1, wherein the front wall of the frame comprising a curved lip portion.

11. The vehicle safety seat of claim 1, further comprising a storage compartment portion coupled to the base portion of the frame to store supplies.

12. The vehicle safety seat of claim 11, wherein the storage compartment portion is to receive a tray assembly to stow underneath the base portion.
